(19) United States
(12) Patent Application Publication
(10) Pub. No.: US 2010/0021804 A1
(43) Pub. Date: Jan. 28, 2010

(54) BATTERY COVER MECHANISM

(75) Inventors: YU ZHANG, Shenzhen City (CN); SHUI-JIN DONG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/464,192

(22) Filed: May 12, 2009

(30) Foreign Application Priority Data
Jul. 23, 2008 (CN) 200810302948.7

(51) Int. Cl. H01M 2/10

(52) U.S. Cl. 429/100

(57) ABSTRACT

A battery cover mechanism used in a portable electronic device includes a housing, a cover and an operating unit. The housing defines a receiving groove therein for receiving a battery. The cover is assembled on the housing to cover the receiving groove. The operating unit is mounted on the cover and includes a movable operating member and at least one movable retaining member driven by the operating member. The operating member is moved to fix one portion of the cover on the housing and the retaining member is driven to move perpendicularly to the movement of the operating member to fix another portion of the cover on the housing.

### BACKGROUND

1. Field of the Invention

The present invention relates to battery cover mechanisms, particularly to a battery cover mechanism used in portable electronic devices.

2. Description of Related Art

Portable electronic devices such as mobile phones and personal digital assistants (PDA) are widely used. Changeable batteries are installed in most portable electronic devices to supply electric power. When a battery is installed in a portable electronic device, it is generally shielded and fixed in place by a battery cover mechanism, thus the battery and the inner circuits of the portable electronic device are well protected.

A conventional battery cover mechanism generally includes a cover and a housing. The cover tightly engages with the housing to be secured thereon. However, due to the tight engagement of the cover and the housing in many conventional designs, a significant amount of impact and friction exist between the cover and the housing. As a result, the user may need to apply a significant amount of strength to assemble/disassemble the cover to/from the housing. Further, the cover and the housing may be distorted or even damaged by impact or friction between each other in the assembly/disassembly operation.

Therefore, there is room for improvement within the art.

### BRIEF DESCRIPTION OF THE DRAWINGS

Many aspects of the present battery cover mechanism can be better understood with reference to the following drawings. The components in the various drawings are not necessarily drawn to scale, the emphasis instead being placed upon clearly illustrating the principles of the present battery cover mechanism. Moreover, in the drawings, like reference numerals designate corresponding parts throughout the diagrams.

FIG. 1 is a disassembled view of a battery cover mechanism, according to an exemplary embodiment.

FIG. 2 is a disassembled view of the battery cover mechanism shown in FIG. 1, but shown in another view angle.

FIG. 3 is an assembled, partially cut-away view of the battery cover mechanism shown in FIG. 1, wherein the battery cover mechanism is in a close mode.

FIG. 4 is an assembled view of the battery cover mechanism shown in FIG. 1, wherein the battery cover mechanism is in a close mode, but shown in another view angle.

FIG. 5 is an assembled, partially cut-away view of the battery cover mechanism shown in FIG. 1, wherein the battery cover mechanism is in an open mode.

### DETAILED DESCRIPTION OF THE EMBODIMENT

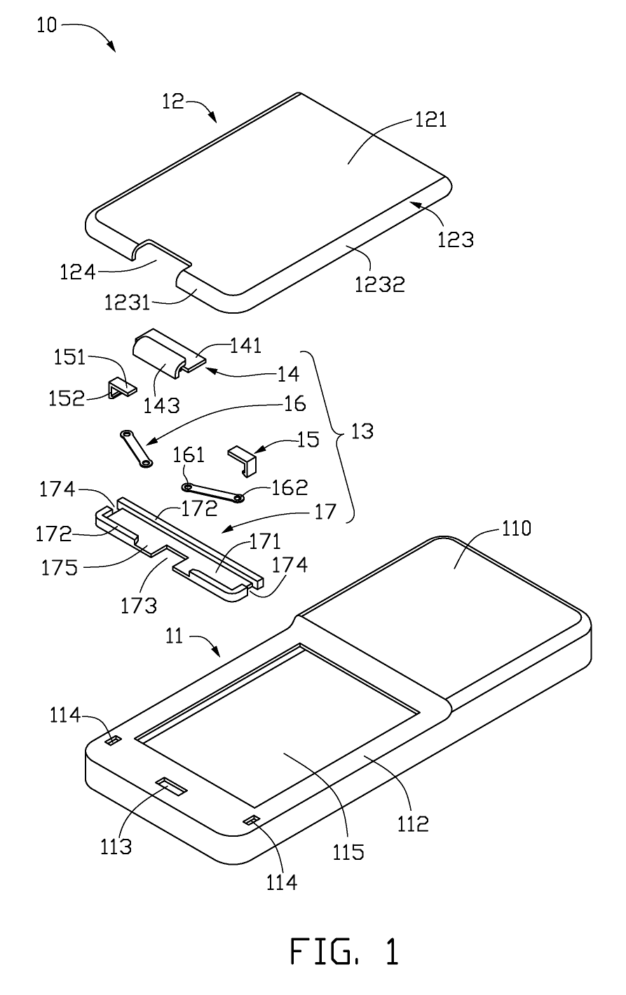

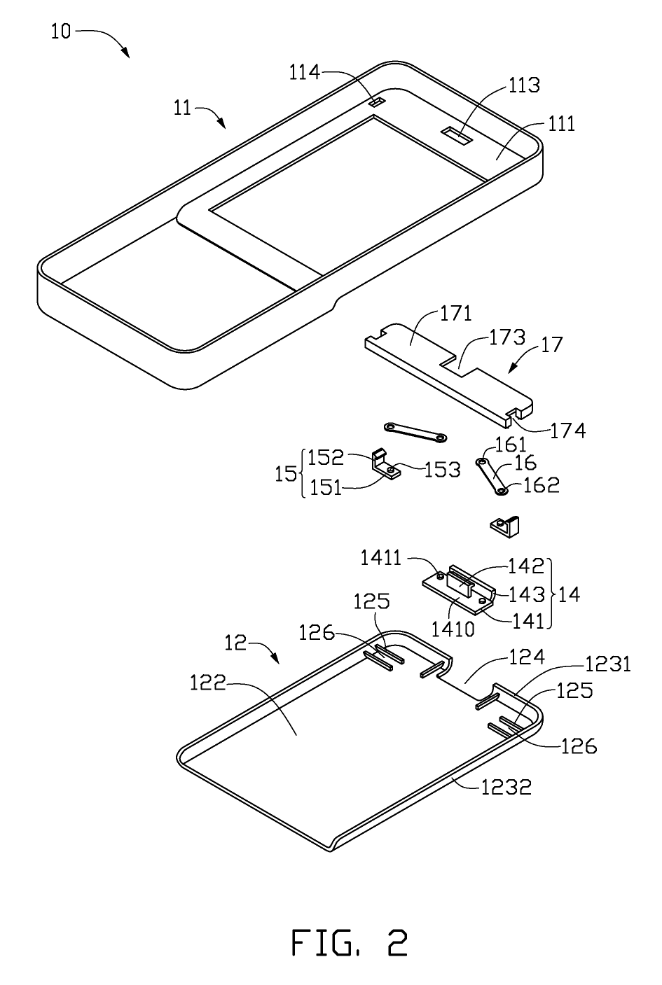

FIGS. 1 and 2 show a battery cover mechanism 10 according to a first exemplary embodiment. While the exemplary battery cover mechanism 10 is used in a mobile phone, it can also be used in other portable electronic devices, such as a personal digital assistant (PDA), a digital camera, etc. The battery cover mechanism 10 includes a housing 11, a cover 12, and an operating unit 13. The operating unit 13 is mounted on the cover 12 to detachably assemble the cover 12 to the housing 11.

The housing 11 can be a part of the housing of a portable electronic device. The housing 11 is approximately rectangular shaped and includes an outer surface 110 and an opposite inner surface 111. A part of the outer surface 110 defines a recessed assembling surface 112. An assembling hole 113 and two retaining holes 114 are defined in an end of the assembling surface 112. The assembling hole 113 is defined in a middle portion of the end of the assembling surface 112, and the retaining holes 114 are defined in two outer corners (not labeled) of the assembling surface 112. A central portion of the assembling surface 112 defines a receiving groove 115 for receiving a battery (not shown) therein.

The cover 12 is an approximately rectangular panel corresponding to the housing 11. The cover 12 has a planar operating surface 121, a mounting surface 122 on a bottom side of the 12 opposite to the operating surface 121, and corresponding to the assembling surface 112, and an edge frame 123 perpendicularly formed on a peripheral portion of the mounting surface 122 to surround three sides of the mounting surface 122. The edge frame 123 includes an end wall 1231 and two parallel side walls 1232 perpendicularly connectable to two ends of the end wall 1231. The cover 12 can be assembled to the assembling surface 112 of the housing 11 using the edge frame 123 to cover the battery in the receiving groove 115.

A cover notch 124 corresponding to the assembling hole 113 is defined in a middle portion of the end wall 1231. Four straight limiting members 125 protrude on the mounting surface 122. The limiting members 125 are all positioned adjacent to the end wall 1231 and parallel to the end wall 1231. Two limiting members 125 are perpendicularly connected to one side wall 1232 to form a guiding groove 126 between the two limiting members 125, and other two limiting members 125 are perpendicularly connected to another side wall 1232 to form another guiding groove 126. The two guiding grooves 126 are positioned to correspond to the two retaining holes 114.

The operating unit 13 includes an operating member 14, two retaining members 15, two driving arms 16 and a pedestal 17. The operating member 14 includes a base 141, an assembling hook 142 and an operating component 143. A length of the base 141 is longer than that of the cover notch 124. The base 141 includes a planar retaining surface 1410 and two first locating poles 1411 perpendicularly protruding from two ends of the retaining surface 1410. The assembling hook 142 is formed on the retaining surface 1410 and positioned between the two first locating poles 1411, and the assembling hook 142 is configured to correspond to the assembling hole 113. The operating component 143 is a bent sheet connected to a side of the base 141 and corresponding to the cover notch 124, and an outer shape of the operating component 143 is configured to be similar to that of the end wall 1231.

Each retaining members 15 is an L-shaped sheet including a sliding portion 151 and a retaining portion 152. The sliding portion 151 is a planar sheet including a second locating pole 153 perpendicularly protruding from the sliding portion 151. The two sliding portions 151 are configured to correspond to the two guiding grooves 126, such that the two sliding portions 151 can be slidably received in the two guiding grooves 126. The retaining portion 152 is a hook perpendicularly connected to an end of the sliding portion 151. The two retaining portions 152 are configured to correspond to the two retaining holes 114. Each driving arm 16 is bar-shaped and defines a first connecting hole 161 corresponding to a first locating pole 1411 in one end and a second connecting hole 161 corresponding to a second locating pole 153 in another end. Thus, the first locating poles 1411 and the second locating poles 153 can be rotatably received in their corresponding connecting holes 161/162, respectively.

The pedestal 17 includes a holding member 171 and a retaining wall 172 perpendicularly connected to a side of the holding member 171 to surround the holding member 171. The holding member 171 defines a pedestal notch 173 corresponding to the assembling hole 113 in a middle portion thereof. The retaining wall 172 defines two side apertures 174 and a middle aperture 175 therein. The two side apertures 174 are respectively defined adjacent to two ends of the holding member 171, and are positioned to be respectively corresponding to the two retaining holes 114. The middle aperture 175 is positioned to be corresponding to the pedestal notch 173.

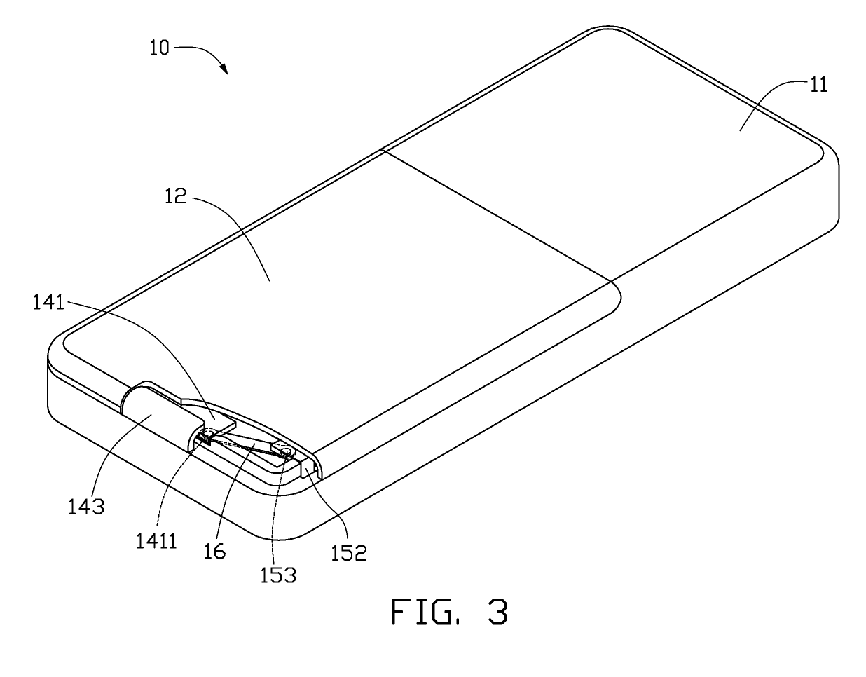

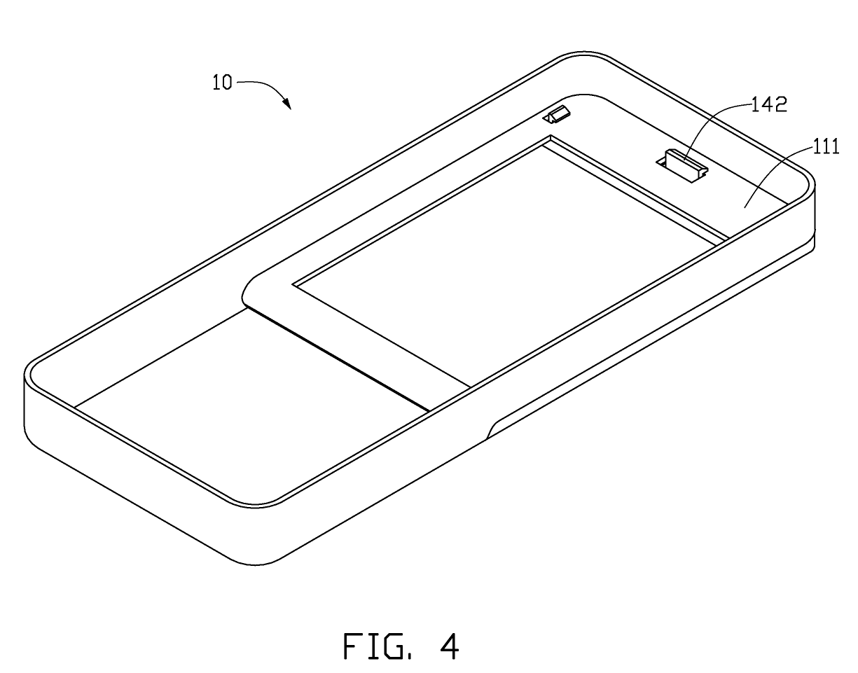

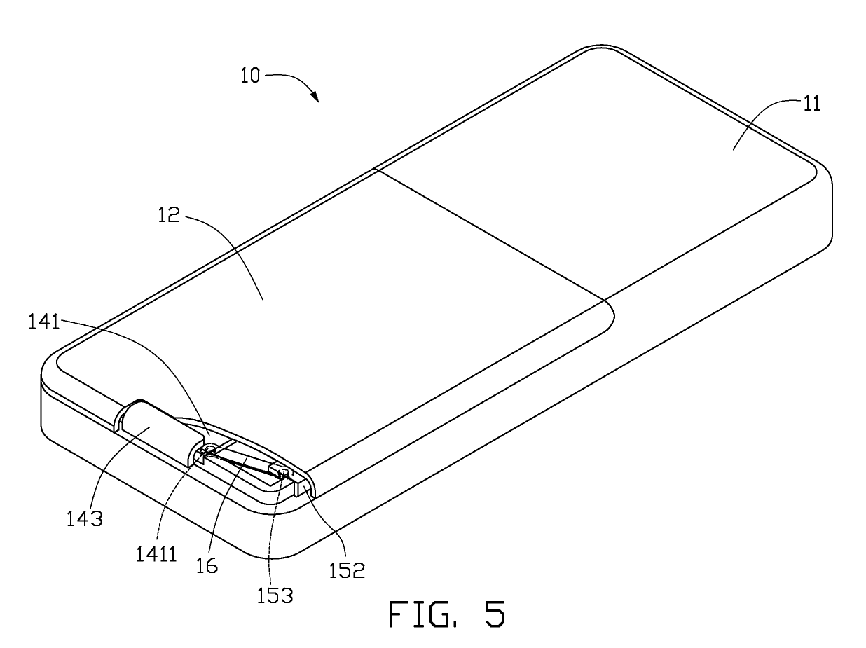

Also referring to FIG. 3, FIG. 4 and FIG. 5, in assembly, the operating member 13 is mounted between the housing 11 and the cover 12. Particularly, the base 141 is placed on the mounting surface 122, and the operating component 143 is received in the cover notch 124. Because the length of the base 141 is larger than the length of the cover notch 124, when the operating component 143 is operated, the base 141 cannot be moved out from the cover notch 124. The sliding portions 151 of the two retaining members 15 are respectively slidably received in the two guiding grooves 126. The first leading poles 1411 are respectively inserted into the first connecting holes 161 of the two driving arms 16 to be rotatably received therein, and the second leading poles 153 are respectively inserted into the second connecting holes 162 of the two driving arms 16 to be rotabably received therein. Thus, when the operating component 143 is pressed into the cover notch 124, the driving arms 16 are pushed outwards by the first locating poles 1411 on the base 141, and the second locating poles 153 are driven by the driving arms 16 such that the two retaining members 15 respectively slide away from each other in their corresponding guiding grooves 126. When the operating component 143 is pulled outwards from the gap 124, the two retaining members 15 are pulled to slide towards each other in their corresponding guiding grooves 126. Understandably, the moving direction of the operating member 14 is perpendicular to that of the retaining members 15.

Finally, the pedestal 17 is covered on the operating member 14, the driving arms 16 and the retaining members 15. The retaining wall 172 is positioned between the holding member 171 and the mounting surface 122, and then is secured on the mounting surface 122. The assembling hook 142 extends out from the middle aperture 175 and the pedestal notch 173, and the two retaining portions 152 respectively extend out from the two side apertures 174. Thus, the operating unit 13 is mounted on the cover 12, and the operating member 14, the drive arms 16 and the retaining members 15 are limited between the pedestal 17 and the cover 12 and prevented from falling out.

When the cover 12 needs to be assembled to the housing 11, the operating component 143 is pressed into the cover notch 124. The base 141 is then pushed into the cover notch 124, and the driving arms 16 are pushed outwards by the first locating poles 1411 on the base 141. The second locating poles 153 are driven by the driving arms 16 such that the two retaining members 15 respectively slide away from each other in their corresponding guiding grooves 126. When the assembling hooks 142 and the retaining portions 152 moves to determined positions corresponding to the assembling hole 113 and the retaining holes 114, respectively, the cover 12 can be assembled to the housing 11, with the mounting surface 122 positioned towards the assembling surface 112.

When the cover is assembled to the housing 11, the assembling hook 142 is inserted into the assembling hole 113, and the retaining portions 152 are respectively inserted into the retaining holes 114. The operating component 143 is then pulled outwards from the cover notch 124 until the base 141 is blocked by the end wall 1231, thus the assembling hook 142 in the assembling hole 113 engages with the inner surface 111 to fix the cover 12 on a middle portion of the housing 11. At the same time, the retaining members 15 are pulled towards each other by the base 14 and the driving arms 16, and the retaining portions 152 in the retaining holes 114 engage with the inner surface 111 and fix the cover 12 on two sides of the housing 11. Finally, the operating component 143 can be secured by conventional releasable fixing mechanisms, then the cover 12 is mounted on the housing 11 to cover the receiving groove 115, with the operating component 143 exposing out form the cover notch 124.

When the cover 12 needs to be detached from the housing 11, the operating component 143 is pressed into the cover notch 124 to drive the two retaining members 15 outwards. When the assembling hook 142 and the retaining portions 152 are moved to release from the engagement with the housing 11, the assembling hook 142 and the retaining portions 152 can be taken out from the assembling hole 113 and the retaining holes 114, such that the cover 12 is detached from the housing 11.

Understandably, either of the two retaining members 15 can be omitted. Either of the two driving arms 16, the two guiding grooves 126 and the two side apertures 174 can also be omitted.

In the exemplary battery cover mechanism 10, the cover 12 is installed on the housing 11 through the operating unit 13, and can be detached from the housing 11 by operating the operating unit 13. The cover 12 and the housing 11 need not to be tightly engage with each other directly, thus minimized the impact or friction generated between the cover 12 and the housing 11 in assembly and disassembly operations. Therefore, the cover 12 and the housing 11 can be well protected.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A battery cover mechanism used in a portable electronic device, comprising:
a housing defining a receiving groove therein for receiving a battery;
a cover for assembly on the housing to cover the receiving groove; and
an operating unit mounted on the cover and including a movable operating member and at least one movable retaining member driven by the operating member, wherein the operating member is moved to fix one portion of the cover on the housing and the retaining member is driven to move perpendicularly to the movement of the operating member to fix another portion of the cover on the housing.

2. The battery cover mechanism as claimed in claim 1, wherein the operating unit includes two movable retaining members driven by the operating member, and the two retaining members are driven to move perpendicularly to the movement of the operating member and fix two sides of the cover on the housing.

3. The battery cover mechanism as claimed in claim 1, wherein the housing defines an assembling hole receiving the operating member therein and at least one retaining holes receiving the retaining member therein.

4. The battery cover mechanism as claimed in claim 1, wherein the operating member includes a base, an assembling hook engaging with the housing to fix the cover and an operating component exposed out to be operated, the assembling hook and the operating component being both formed on the base.

5. The battery cover mechanism as claimed in claim 4, wherein the cover defines a cover notch therein for receiving the operating component and exposing the operating component out to be operated.

6. The battery cover mechanism as claimed in claim 4, wherein the operating unit further includes at least one driving arm rotatably connecting the base and the retaining member such that movement of the operating component drives the retaining member to move.

7. The battery cover mechanism as claimed in claim 6, wherein the cover defines at least one guiding groove therein, the retaining members are received in the grooves and capable of slide therein.

8. The battery cover mechanism as claimed in claim 6, wherein the operating unit further includes a pedestal secured on the cover to limit the operating member, the driving arm and the retaining member between the pedestal and the cover.

9. The battery cover mechanism as claimed in claim 8, wherein the pedestal defines a pedestal notch and at least one side aperture, and the assembling hook exposes out from the pedestal notch and the retaining member exposes out from the side aperture for engaging with the housing.

10. A battery cover mechanism used in a portable electronic device, comprising:
a housing defining a receiving groove therein for receiving a battery;
a cover for assembly on the housing to cover the receiving groove; and
an operating unit mounted on the cover and including a movable operating member and at least one movable retaining member driven by the operating member, wherein the operating member engages with one portion of the housing and the retaining member engages with another portion of the housing to fix the cover on the housing when the operating member is moved towards a first direction, and the operating member and the retaining members are moved to release from the engagement with the housing to detach the cover from the housing when the operating member is moved towards an opposite second direction.

11. The battery cover mechanism as claimed in claim 10, wherein the operating unit includes two movable retaining members driven by the operating member, and the two retaining members fix two sides of the cover on the housing.

12. The battery cover mechanism as claimed in claim 10, wherein the housing defines an assembling hole receiving the operating member therein and at least one retaining holes receiving the retaining member therein.

13. The battery cover mechanism as claimed in claim 10, wherein the operating member includes a base, an assembling hook engaging with the housing to fix the cover and an operating component exposed out to be operated, the assembling hook and the operating component being both formed on the base.

14. The battery cover mechanism as claimed in claim 13, wherein the cover defines a cover notch therein for receiving the operating component and exposing the operating component out to be operated.

15. The battery cover mechanism as claimed in claim 13, wherein the operating unit further includes at least one driving arm rotatably connecting the base and the retaining member such that movement of the operating component drives the retaining member to move.

16. The battery cover mechanism as claimed in claim 15, wherein the cover defines at least one guiding groove therein, the retaining members are received in the grooves and capable of slide therein.

17. The battery cover mechanism as claimed in claim 15, wherein the operating unit further includes a pedestal secured on the cover to limit the operating member, the driving arm and the retaining member between the pedestal and the cover.

18. The battery cover mechanism as claimed in claim 17, wherein the pedestal defines a pedestal notch and at least one side aperture, and the assembling hook exposes out from the pedestal notch and the retaining member exposes out from the side aperture for engaging with the housing.
